(19) United States
(12) Patent Application Publication
(10) Pub. No.: US 2006/0208603 A1
(43) Pub. Date: Sep. 21, 2006

(54) Rotating electric machine with variable length air gap

(75) Inventor: John Harnsworth Kerlin IV, Provo, UT (US)

Correspondence Address: JONES DAY, 2882 SAND HILL ROAD, SUITE 240, MENLO PARK, CA, 94025, US

(73) Assignee: RT Patent Company, Inc., Wilmington, DE (US)

(21) Appl. No.: 11/084,550

(22) Filed: Mar. 18, 2005

(51) Int. Cl. H02K 1/22

(52) U.S. Cl. 310/261

(57) ABSTRACT

A variable reluctance electric motor is disclosed. The motor has a generally circularly shaped stator core having at least one pole and a winding disposed thereon. Furthermore, the motor has a rotor core with at least one rotor lobe and configured to be insertable into the stator core. A gap is defined between the stator core and rotor core. The radius of the rotor core is configured to vary the length of the gap between the rotor lobe(s) and the stator pole(s) when rotating within the stator core in order to create a variable reluctance machine.

### FIELD OF THE INVENTION

The present invention generally relates to variable reluctance electrical machines and more particularly to a variable reluctance electrical motor whereby the length of the air gap between the rotor lobe and stator pole varies during the torque cycle as a function of rotor position in order to increase torque and efficiency within the motor.

### BACKGROUND OF THE INVENTION

Common to all forms of conventional electromotive machines is the division of electrical energy into two equal components of magnetic and mechanical energy. This effect may be expressed as:
ΔE_{electrical}→−(ΔE_{magnetic}+ΔE_{mechanical}) Eq.1

In this regard, the electrical energy splits into mechanical and magnetic energy in accordance with the law of equi-partition of energy:
ΔE_{magnetic}=ΔE_{mechanical} Eq.2

Substituting Eq. 2 into Eq. 1:
ΔE_{electrical}=2ΔE_{magnetic}=2ΔE_{mechanical} or: ½ΔE_{electrical}=ΔE_{magnetic}=ΔE_{mechanical} Eq.3

Thus half of the electrical energy appears as unwanted magnetic energy and the other half as useful mechanical energy. Only the mechanical energy is extracted while the co-created magnetic energy must be recovered and recycled to retain system efficiency. Failure to reclaim or recycle this significant quantity of energy (i.e., co-energy), yields a theoretical efficiency of no greater than 50% for an otherwise ideal machine of zero dissipative losses.

The lost co-energy is not the same as reactive energy. The reactive energy has out-of-phase current and voltage components that result in zero net power gain or loss when integrated over a full electrical cycle. Co-energy, on the other hand, is exactly in-phase with the mechanical energy and represents actual net energy that does not necessarily circulate in and out of the electric circuit as does reactive energy.

In poly-phase AC machines, co-energy never leaves the machine but is trapped continuously in the rotor-stator air gap as it transfers from phase to phase. In the AC machine there is no need for co-energy recovery methods. Each individual phase does see a complete cycle of co-energy per torque cycle corresponding directly to the production of mechanical energy according to Eq. 2.

Generation of magnetic co-energy always accompanies torque production when the electrical/mechanical conversion process occurs simultaneously. In the motor mode, electrical input energy splits into equal components of mechanical and magnetic co-energy. In the generator mode, mechanical input energy splits into equal components of electrical and magnetic co-energy.

Conventional variable reluctance machines (VRM) create a magnitude of co-energy exactly equal to the production of mechanical energy. Unlike the AC machine, however, the co-energy does not automatically transfer among phases but must be deliberately managed to assure efficient operation.

Two primary “equations-of-state” lie at the core of electromotive theory. Both of these fundamental equations show the interrelationship of electric circuit and magnetic circuit parameters constituting an electromotive machine.

One equation-of-state is derived from Ampere's magnetic circuit laws, which is actually the magnetic analog to Ohm's Law for electric circuits:
mmf=ni=Φ [symbol] (magnetic circuit) emf=v=iR(electric circuit)
Or:

$$i = \frac{ϕ }{n} or solving for flux \text{:} ϕ = \frac{ni}{} \qquad Eq . 4 A$$

Where: n=number of coil turns

i=coil current

Φ=magnetic flux

[symbol] =magnetic circuit reluctance due to the air gap

v=voltage

R=electric circuit resistance

Thus amp-turns ni is the “Magneto-Motive Force” (mmf) that drives flux Φ through a magnetic circuit of reluctance [symbol] which is analogous to “Electro-Motive Force” (emf or voltage v) that drives current i through an electric circuit of resistance R. Magnetic circuit “reluctance” simply represents impedance to flux flow created by low permeability of the air gap just as resistance in an electric circuit restricts current flow created by low conductivity when a resistor is placed in the circuit.

The other equation-of-state relates to voltage induced in an electric circuit by changes in magnetic flux amplitude, first propounded in Faraday's Law of Electromagnetic Induction:

$$v = - n \frac{ⅆ ϕ}{ⅆ t} \qquad Eq . 5$$

The negative sign in Eq.5 indicates that the induced voltage v acts in a direction to oppose any change in amplitude of current thereby imparting an “inertial” or “mass” property to an inductor. This effect, known as Lenz's Law, allows the inductor to serve as a “constant current source” in the same way that a capacitor serves as a “constant voltage source”.

Based on the intrinsic definition of current i as Coulomb charge flow-rate i=dq/dt, and voltage v=dE/dq as energy per unit charge, then the product iv is equal to the rate-of-change of energy, known as electric power P where:

$$P = \frac{ⅆ E}{ⅆ t} = iv \qquad Eq . 6$$

Therefore,
dE_{E}=Pdt=ivdt Eq.7
Where: E_{electrical}→E_{E}=electrical energy to simplify the subscripts
Substituting Eqs.4A and 5 into Eq.7:

$$ⅆ {E}_{E} = - ( \frac{ϕ }{} ) ( \frac{ⅆ ϕ}{ⅆ} ) \qquad Eq . 8$$

Integrating Eq.8 at constant reluctance [symbol] starting from zero flux:

$$Δ {E}_{E} = - {\int }_{0}^{ϕ} ϕ ⅆ ϕ = - \frac{1}{2} {ϕ}^{2} = - Δ {E}_{M} \\ Δ {E}_{M} = \frac{1}{2} {ϕ}^{2} ( stored gap magnetic energy ) \qquad Eq . 9$$

Where: E_{M}=magnetic energy stored in the gap

Reluctance [symbol] was held constant during the integration of Eq.9. Because a fixed inductor produces no mechanical energy, then electrical energy is stored solely in the air gap in the form of magnetic energy. Thus Eq.9 represents only stored inductor magnetic energy.

Substituting Eq.4A into Eq.9:

$$Δ {E}_{M} = \frac{1}{2} {i}^{2} ( \frac{{n}^{2}}{ℜ} ) = \frac{1}{2} {i}^{2} ( \frac{{n}^{2}}{ℜ} ) \qquad Eq . 10$$

Let inductor inductance L be defined as:

$$L = ( \frac{{n}^{2}}{} ) \qquad Eq . 11$$

Then Eq.10 may be written:

$$Δ {E}_{M} = \frac{1}{2} {i}^{2} L ( gap magnetic energy ) \qquad Eq . 12$$

An alternative expression for Inductance L may be found by equating Eqs.9 and 12 and using Eq.4A for Φ:

$${i}^{} L = {ϕ}^{2} = ϕ ( \frac{n }{} ) so that \text{:} \\ L = ( \frac{n}{i} ) ϕ \qquad Eq . 13$$

Eq.13 is especially useful for evaluating smooth-bore AC machines where there are no changes in the physical dimensions defining flux containment volume. AC machines experience a change in flux Φ at constant current i due to variations in angular orientation of rotor and stator coils which results in a change of machine inductance according to Eq.13.

By contrast, Eq.11 is used in evaluating a VRM having only a single coil where no mutual coil interaction can exist. A change in inductance can only occur by altering the volume of the flux cavity formed between interfacing rotor and stator poles. Variations in cavity dimensions cause reluctance [symbol] to change and hence a change in machine inductance according to Eq.11. Inasmuch as this analysis applies only to VRMs, Eq.11 alone is invoked for inductance L.

By definition, flux Φ is expressed in terms of gap area A_{g} and gap flux density B_{g}:
Φ=A_{g}B_{g} Eq.14
Where: A_{g}=gap cross-sectional area

B_{g}=flux density
Substituting Eq.14 into Eq.9:

$$Δ {E}_{M} = \frac{1}{2} {A}^{2} {B}_{g}^{2} \qquad Eq . 15$$

Let reluctance [symbol] be defined as:

$$ℜ = \frac{{l}_{g}}{{A}_{g} {μ}_{o}} \qquad Eq . 16$$

Where: I_{g}=gap length in the direction of magnetic lines of force; and

μₒ=permeability of air, i.e., gap permeability
Substituting Eq.16 into Eq.15:

$$= \frac{1}{2 {μ}_{o}} ( {A}_{g} {l}_{g} ) {B}_{g}^{2} = \frac{1}{2 {μ}_{o}} {V}_{g} {B}_{g}^{2} \qquad Eq . 17$$

Where: V_{g}=A_{g}l_{g}=gap volume occupied by magnetic flux

Magnetic energy residing within the air gap is shown by Eq.17 to be proportional to gap volume V_{g} and the square of flux density B_{g}. Also note that stored magnetic energy is inversely proportional to gap permeability μₒ which explains why an ideal transformer having a core of infinite permeability, μₒ→∞, cannot store magnetic energy. An inductor capable of storing appreciable magnetic energy requires a gap of low permeability such as air.

Differentiating Eq.12 while holding inductance L constant yields:

$$ⅆ {E}_{E} = iv ⅆ t = - ⅆ {E}_{M} = - ⅆ ( \frac{1}{2} {i}^{2} L ) = - iL \frac{ⅆ i}{ⅆ t} \qquad Eq . 18$$

Dividing both sides of Eq.18 by i:

$$v = - L \frac{ⅆ i}{ⅆ t} \qquad Eq . 19$$

The familiar term L di/dt of Eq.19 is the reactive component inasmuch as di/dt is 90° out-of-phase with current i. Therefore voltage v arising from L di/dt must also be 90° out-of-phase with current i resulting in non-real reactive power. Time-varying current di/dt alone does not produce mechanical energy and, in fact, produces no real energy of any kind. Electromotive theory therefore ignores the reactive term as making no contribution to real energy. In short, a changing current di is not involved in the production of mechanical energy.

Mechanical shaft energy E_{S} is due solely to mechanical motion causing a change in machine inductance dL. Given the equivalence of magnetic and mechanical energy, required by the Law of Conservation of Energy, then Eq.3 may be written differentially using Eq.12:

$$ⅆ {E}_{M} = - ⅆ {E}_{S} = - \frac{1}{2} {i}^{2} ⅆ L ( “ real ” energy ) \qquad Eq . 20$$

In Eq.20 current i is held “quasi-constant”, meaning that although current may vary (e.g., sinusoidally), current is considered constant during the change of differential inductance element dL.

Determining now the total electrical energy entering a variable inductor, i.e., a VRM of conventional design, substitute Eq.5 into Eq.7, using Eq.14 for the definition of Φ, and differentiating at constant current i:

$$ⅆ {E}_{E} = iv ⅆ t = - i ( \frac{n ⅆ ϕ}{ⅆ} ) ⅆ = - ni ⅆ ϕ = - {niB}_{g} ⅆ {A}_{g} \qquad Eq . 21$$

Dividing both sides by idt:

$${v}_{e mf} = {nB}_{g} \frac{ⅆ {A}_{g}}{ⅆ t} \qquad Eq . 21 A$$

Voltage v_{emf} is the conventional VRM internally generated voltage known as “back-emf” in the case of a motor or “forward-emf” with regard to a generator. There is no difference between back-emf and forward-emf except direction relative to current flow. As suggested by the term, “back-emf” opposes current flow in a motor and “forward-emf” promotes current flow in a generator.

Eq.21A shows machine voltage v_{emf} as a function of changing flux dΦ due to time-rate-of-change of area dA_{g}/dt. In other words, v_{emf} is directly proportional to shaft speed which dictates a constant “volts/Hz ratio” as determined by the basic machine configuration of turns n and total flux capacity Φ. Because voltage v_{emf} is strictly a function of shaft frequency, the generation of machine voltage produces no heat above that of the thermal energy required to create flux Φ due to winding current.

A conventional VRM, employing simultaneous energy conversion, produces an internal voltage v_{emf} that is equally divided between mechanical energy and real magnetic co-energy and is therefore twice the value required for shaft power alone, a situation reinforcing the necessity for co-energy recovery.

Substituting Eqs.14 and 16 into Eq.4:

$$ni = {A}_{g} {B}_{g} ℜ = \frac{ {B}_{g} {l}_{g}}{ {μ}_{o}} \\ i = \frac{1}{n {μ}_{o}} {B}_{g} {l}_{g} \qquad Eq . 22$$

Eq.22 shows that in a standard VRM with constant gap length l_{g}, current i is held constant in order to maintain fixed B_{g} near saturation during maximum torque production, the optimal operating condition. Because area gap A_{g} cancels out in Eq.22, variable area dA_{g} has no effect on either current or flux density, only voltage v_{emf} as given by Eq.21A.

Substituting Eq.22 into Eq.21:

$$\begin{matrix}ⅆ {E}_{ E} = - ( \frac{1}{ {μ}_{ o}} {B}_{ g} {l}_{ g} ) {B}_{ g} ⅆ {A}_{ g} \\ = - \frac{1}{{μ}_{o}} {B}_{g}^{2} ( {l}_{g} ⅆ {A}_{g} ) \\ = - \frac{1}{{μ}_{o}} {B}_{g}^{2} ⅆ {V}_{g}\end{matrix} \\ ⅆ {E}_{E} = - \frac{1}{{μ}_{o}} ⅆ {V}_{g} {B}_{g}^{2} \qquad Eq . 23$$

Comparing Eq.23 for electrical energy ΔE_{E} with Eq.17 for magnetic energy ΔE_{M} shows:

$$Δ {E}_{E} = - 2 Δ {E}_{M} or \frac{1}{2} Δ {E}_{E} = - Δ {E}_{M} \qquad Eq . 24$$

Only half the electrical energy ΔE_{E} is shown by Eq.24 to appear in the form of magnetic energy ΔE_{M}. The remaining half appears as mechanical or “shaft” energy ΔE_{S} so that:
ΔE_{E}=−[ΔE_{S}+ΔE_{M}] Eq.25
ΔE_{S}=ΔE_{M} (conventional VRM) Eq.26

Where: ΔE_{M}=“real” magnetic co-energy produced concurrent with production of shaft (mechanical) energy ΔE_{S} in prior-art VRM practice. Note the similarity of Eqs.25 and 26 to Eqs.2 and 3 as a manifestation of the principle of “Equi-Partition of Energy”. This is the standard single-step simultaneous conversion of electrical energy into mechanical energy with concomitant creation of co-energy.

Combining Eqs.23, 24 and 26 gives:

$${dE}_{S} = \frac{1}{2 {μ}_{o}} {dV}_{g} {B}_{g}^{2} = \frac{1}{2 {μ}_{o}} {l}_{g} {dA}_{g} {B}_{g}^{2} \qquad Eq . 27$$

Further investigation illuminates the exact mechanism by which torque is generated in standard VRM practice. Let:
dA_{g}=h_{g}dS_{g}=h_{g}r_{g}dθ_{S} Eq.28
Where: h_{g}=gap axial length in an axial-type machine;

S_{g}=arc distance through which a rotor pole rotates relative to a stator pole=r_{g}S_{g}; and

θ_{S}=angle of shaft rotation

Substituting Eq.28 into Eq.27:

$${dE}_{S} = \frac{1}{2 {μ}_{o}} {r}_{g} ( {l}_{g} {h}_{g} ) {dS}_{g} {B}_{g}^{2} = \frac{1}{2 {μ}_{o}} {r}_{g} {A}_{g - norm} {dS}_{g} {B}_{g}^{2} \qquad Eq . 29$$

Note that the quantity (h_{g}l_{g}) is the gap area whose plane is normal to the tangential torque vector, where:
(h_{g}l_{g})=A_{g-norm} Eq.30

By definition, let:
dE_{S}=T_{P}dθ_{S} Eq.31
Where: T_{P}=shaft torque per pole

Substituting Eq.31 into Eq.29:

$${T}_{P} d {g}_{} = \frac{1}{2 {μ}_{o}} {r}_{g} {A}_{g - norm} d {g}_{} {B}_{g}^{2} \\ {T}_{P} = \frac{1}{2 {μ}_{o}} {r}_{g} {A}_{g - norm} {B}_{g}^{2} ( torque per pole ) \qquad Eq . 32$$

But torque T_{P} is defined as simply a force F acting normal to gap radius r_{g}:
T_{P}=Fr_{g} Eq.33

Substituting Eq.33 into Eq.32:

$$F {g}_{} = \frac{1}{2 {μ}_{o}} {g}_{} {A}_{g - norm} {B}_{g}^{2} \\ F = \frac{1}{2 {μ}_{o}} {A}_{g - norm} {B}_{g}^{2} \qquad Eq . 34$$

Eq.34 is immediately recognized as the formula for magnetic force. However, because the plane of area A_{g-norm} is not normal to the magnetic lines-of-force, as is the case for “attractive” magnetic force, then the force of Eq.34 expresses the “expansive” magnetic force that acts perpendicular to the lines-of-force.

It is known that a magnetic field has two force components: 1) a longitudinal tensile force attempting to contract the field in a direction parallel to the lines-of-force; and 2) an expansive force causing the lines-of-force to behave like slender gas-filled balloons pushing one another apart transversely. This phenomenon could be compared to gas “pressure” acting in a 2-dimensional context except that the 3^{rd} longitudinal dimension is contractive rather than expansive.

Eq.34 shows the expansive magnetic force is exactly equal to the attractive force for a given area A_{g} and flux density. The only difference is the direction of force, not amplitude. Expansive force is always perpendicular to the attractive force. In a motor, then, the torque-producing tangential force would be equal to the radial magnetic force if the normal area A_{g-norm} were equal to the radial area A_{g-radial}.

Total shaft torque is the summation torque produced by each pole. Therefore let:
Tₜₒₜ=N_{P}T_{P} Eq.35
Where: Tₜₒₜ=total shaft torque; and

N_{P}=number of machine poles

Substituting Eq.32 into Eq.35:

$${T}_{tot} = {N}_{P} \frac{1}{2 {μ}_{o}} {r}_{g} {A}_{g - norm} {B}_{g}^{2} \qquad Eq . 36$$

Multiplying top and bottom of Eq.36 by k_{g}2π:

$$\begin{matrix}{T}_{tot} = \frac{{N}_{P}}{{k}_{g} 2 π} ( \frac{1}{2 {μ}_{o}} {k}_{g} 2 π {r}_{g} {A}_{g - norm} {B}_{g}^{2} ) \\ = \frac{{N}_{P}}{{k}_{g} 2 π} ( \frac{1}{2 {μ}_{o}} {k}_{g} {V}_{g - tot} {B}_{g}^{2} ) \\ = \frac{{N}_{P}}{{k}_{g} 2 π} ( \frac{1}{2 {μ}_{o}} {V}_{g - M} {B}_{g}^{2} )\end{matrix} \qquad Eq . 37$$

Where: k_{g}=ratio of total pole width (circumferential) to gap circumference,

typically ½

V_{g-tot}=2πr_{g}A_{g-norm}=total geometric gap volume

V_{g-M}=k_{g}V_{g-tot}=total gap flux volume enclosed by rotor-stator poles

From Eq.17 for total magnetic energy ΔE_{M-tot} contained with total flux volume V_{g-M}:

$$Δ {E}_{M - tot} = ( \frac{1}{2 {μ}_{o}} {V}_{g - M} {B}_{g}^{2} ) \qquad Eq . 38$$

Which substituted into Eq.37 gives:

$${T}_{tot} = \frac{1}{{k}_{g} 2 π} {N}_{P} Δ {E}_{M - tot} \qquad Eq . 39$$

Because the value of k_{g} is usually ½, then generally Eq.39 can be stated as:

$${T}_{tot} = \frac{1}{π} {N}_{P} Δ {E}_{M - tot} ( conventional VRM ) \qquad Eq . 40$$

Where: ΔE_{M-tot}=total magnetic energy storage capacity of the machine

Except for the variations in multiplier 1/π for different machine types, the fundamental essence of torque production in any conceivable electromotive machine, AC or VRM, is expressed fully by Eq.40. Torque production is rendered in terms of just two fundamental parameters: 1) the number of poles N_{P}; and 2) the total magnetic energy ΔE_{M-tot} contained within the machine, which is directly proportional to overall machine size for a given gap-to-radius ratio. Inasmuch as magnetic energy is contained mostly within the rotor-stator gap volume, then clearly gap length l_{g} becomes of critical importance. But because current i is necessary to create flux density B_{g} across the gap (see Eq.22), maximum gap length l_{g} is limited by heat generation, i.e., i²R losses. Both torque and heat rise together as functions of the square of current (B²=i²)which means machine efficiency would remain constant irrespective of gap length. However, limitations on the ability to remove heat impose a ceiling on maximum torque production by means of increasing gap length l_{g}, rather than concern for reduced efficiency since efficiency actually remains constant regardless of gap length. The small gap used in conventional practice allows the machine to operate close to flux saturation without overheating. Since conventional small-gap machines operate near saturation but considerably below their thermal limit, it is usually the saturation limit, rather than the thermal limit, that dictates conventional machine peak performance.

In a VRM, the pole number N_{P} states the number of energy-conversion pulses per shaft revolution. N_{P} also represents the ratio of “electrical pulse frequency” ω_{E} to “shaft frequency” ω_{S}. Note: In an AC machine N_{P}/2 gives the same ratio because there are two pulses, positive and negative, per electrical cycle. N_{P} in a VRM represents just one pulse per electrical cycle and may be expressed as:

$${N}_{P} = \frac{{ω}_{E}}{{ω}_{S}} \qquad Eq . 41$$

Where: ω_{E}=electrical pulse frequency in a VRM; and

ω_{S}=shaft frequency

Shaft power P_{S} is defined as:
P_{S}=Tₜₒₜω_{S} Eq.42

Substituting Eqs.41 and 42 into Eq.40:

$${P}_{S} = {T}_{tot} {ω}_{S} = \frac{1}{π} {ω}_{E} Δ {E}_{M - tot} \qquad Eq . 43$$

Substituting Eq.38 into Eq.43:

$${P}_{S} = {ω}_{E} ( \frac{1}{2 {πμ}_{o}} {V}_{g - M} ) {B}_{g}^{2} \qquad Eq . 44$$

Assuming no restriction on heat removal capacity, and given machine size as indicated by flux gap volume V_{g-M}, machine power P_{S} is ultimately determined by the magnetic properties of the core material as demonstrated by Eq.44. Electrical pulse frequency ω_{E} at some point introduces unacceptable hysteresis losses, and to a lesser extent eddy-current losses, that degrade efficiency. Flux density B_{g} is limited to the saturation level of the core material. Ferrite materials hold promise for transcending the frequency limitations incurred by steel laminations although this advantage is somewhat offset by their lower flux density.

The torque cycle of a VRM operates at 50% duty-cycle, meaning the rotor is coasting at zero torque during half of the total torque cycle. At first glance this situation would imply the VRM is inherently limited to half the shaft torque of an AC motor which experiences 100% duty-cycle torque production.

Careful examination disproves this seemingly obvious conclusion. It can be shown that these two types of machines are identical at the most fundamental level.

Both an AC machine and a VRM of given gap volume actually store the same quantity of energy in the magnetically active region comprising about half of the total physical gap volume. Both produce the same rate-of-change of magnetic energy per revolution for a given number of poles. Therefore, according to Eq.44, both types of machines will produce the same power at a given speed, i.e., the same torque.

As described above, the VRM utilizes the expansive magnetic force for torque production thereby creating magnetic co-energy in a single-step process. This co-energy is exactly equal to the shaft energy making salvaging and recycling imperative in order to obtain acceptable machine efficiency. What is needed is a VRM machine that eliminates the need for co-energy recovery following each torque cycle thereby permitting a greater portion of the cycle to be dedicated strictly to torque production.

### SUMMARY OF THE INVENTION

A variable reluctance electric motor is disclosed. The motor has a generally circularly shaped stator core having at least one winding disposed thereon. Furthermore, the motor has a rotor core configured to be insertable into the stator core. The rotor core defines a gap between the stator core and the rotor core. The radius of the rotor core is configured to vary a length of the gap between the rotor core and the stator core when rotating within the stator core in order to create a variable reluctance machine.

The radius of the rotor core is varied to define at least one lobe of the rotor. Typically, the rotor core has a number of lobes corresponding to the number of poles of the motor. The radius of the rotor core is varied sinusoidally in order to form the lobes.

A drive circuit energizes at least one coil disposed around the stator core. Typically, the number of coils corresponds to the number of poles of the motor. The drive circuit is operable to control a magnetic field formed within the gap between the stator core and the rotor core.

### BRIEF DESCRIPTION OF THE DRAWINGS

These, as well as other features of the present invention, will become more apparent upon reference to the drawings wherein:

FIG. 1 is a perspective view of an electrical motor constructed in accordance with the present invention;

FIG. 2 is a perspective view of the motor shown in FIG. 1 with end bells removed;

FIG. 3 is a perspective view of the motor shown in FIG. 2 with stator windings removed;

FIG. 4 is an exploded perspective view of the motor shown in FIG. 3;

FIG. 5 is a plan view of the rotor of the motor shown in FIG. 1;

FIG. 6 is a graph illustrating the curvature of the rotor shown in FIG. 5;

FIG. 7 is a plan view of the stator of the motor shown in FIG. 1;

FIGS. 8A-8H illustrate the rotor shown in FIG. 5 rotating within the stator shown in FIG. 7.

FIG. 9 is a graph illustrating motor current versus torque cycle for the motor shown in FIG. 1;

FIGS. 10A-10C are a controller circuit diagram for the motor shown in FIG. 1;

FIG. 11 is a plan view of a rotor and stator for a sixteen pole motor constructed in accordance with the present invention;

FIG. 12 is an enlargement of the stator-rotor air gap for the stator and rotor shown in FIG. 11;

FIGS. 13 and 14 are perspective views of the sixteen pole motor constructed in accordance with the present invention.

### DETAILED DESCRIPTION

As previously stated, all electromotive machines are innately variable inductors. Any motor or generator not modeled as a variable inductor leads to false conclusions and fails to indicate potential areas for performance improvement.

Inductance can be varied in two ways: (1 )angular variation of rotor-stator coils as found in AC machines; and (2) variation of the physical volume containing magnetic energy as found in all VRM's. Both of these methods produce a change in stored magnetic energy that represents conversion to mechanical energy. The motor of the present invention varies the physical flux cavity volume with a variable gap length dl_{g} at constant interfacing pole area A_{g}. The axial gap length h_{g} (i.e., the third dimension defining a volume) remains fixed in an axial-type machine which is the type assumed throughout this analysis.

A magnetic field has two force components acting perpendicular to one another: 1) a longitudinal attractive force; and 2) a transverse expansive force. As show by Eq.34, these two forces are of equal magnitude under the same conditions of active area A_{g} and flux density B_{g}.

Two different mechanical means are available for enabling magnetic-to-mechanical energy conversion, the choice depending upon whether the magnetic force is in the expansive-mode or the attractive mode. Variable gap area dA_{g} of a conventional VRM extracts the expansive energy of the magnetic field. Variable gap length l_{g} of the present invention extracts the attractive energy of the magnetic field.

Torque production, in a conventional VRM with a variable-area dA_{g} approach under the ideal scenario, proceeds at constant current i and constant gap flux density B_{g} because gap length l_{g} is constant, according to Eq.22. Also, back-emf (or forward-emf) v_{emf} is also constant under these conditions due to the rate-of-change of area dΦ/dt=B_{g}dA_{g}/dt being constant according to Eq.21A at constant shaft speed.

Conversely, the present invention employs a constant gap area A_{g} and variable gap length dl_{g}. Then according to Eq.22, current i must vary with changing dl_{g} if flux density B_{g} is to remain constant under the ideal scenario. Moreover, if gap area A_{g} and flux density B_{g} are both constant, the total flux Φ is also constant and dθ/dt=0. This means machine voltage v_{emf} is zero according to Eq.5. Essentially, energy conversion takes place at zero back-emf in a motor or zero forward-emf in a generator. The emphasis is placed on “energy conversion” taking place at zero voltage. Any conceivable machine must present an internal voltage during some portion of the torque cycle. An additional step is therefore necessary for creating the required internal voltage. In the second step, internal voltage arises during the introduction (motor) or removal (generator) of magnetic energy to or from the rotor-stator air gap. Thus the internal machine voltage v_{emf}, or “emf”, is retained but occurs during the additional step of energy injection (motor) or energy extraction (generator).

Magnetic energy is injected or extracted under the ideal condition of constant inductance (L=constant; dL/dt=0) at the beginning (motor) or end (generator) of the torque cycle. Therefore the machine internal voltage v_{emf} is not generated as a function of rotor rotation creating the dΦ/dt of Eq.5, but rather simply as the opposing voltage of a static inductor following “v_{emf}”=L di/dt. In the complete cycle of a sinusoidal applied voltage, this would be an entirely reactive process (Eq.19) with no net energy delivered to the machine. However, in the case of the innovation, the applied voltage v_{A} initially charges the inductor with energy which in turn is converted to mechanical energy in the subsequent step (motor) rather than returned to the circuit to give zero net power. Applied voltage v_{A} is, in fact, the “emf” inasmuch as di/dt automatically adjusts to whatever value supports the applied voltage for the given inductance L.

Briefly, v_{A}=“v_{emf}”=L dθ/dt=back or forward emf since the machine creates an internal voltage v (Eq.19) which exactly matches the applied voltage V_{A}. Consequently, any shape of voltage waveform may be applied because the machine always responds in kind with a matching voltage. The concept of mismatched waveforms creating so-called “harmonics” is thus meaningless.

The 2-step energy conversion process eliminates production of magnetic co-energy which always accompanies the conventional expansive-mode of simultaneous energy conversion employed exclusively throughout the prior-art, as demonstrated in the derivation of Eqs.23-26.

To the contrary, invoking the 2-step attractive-mode for torque production facilitates consumption, rather than production, of magnetic energy during energy conversion. Due to less-than-ideal mechanical conditions in a practical rotary machine, there will always be a small quantity of residual magnetic energy requiring recovery which amounts to less than 20% of the co-energy that would otherwise be produced in a conventional VRM format.

Analysis of torque production of a motor constructed in accordance with the present invention relies upon equations previously derived for the conventional VRM. Only the motor-mode will be shown with the understanding that the generator mode is the same operation but in reverse.

The overall 2-step process consists of: 1) conversion of electrical energy to magnetic energy; and 2) conversion of magnetic energy to mechanical energy. Shown as a flow diagram:
ΔE_{E}→ΔE_{M}→ΔE_{S} Eq.45
Where: ΔE_{E}=electrical energy

ΔE_{M}=magnetic energy

ΔE_{S}=mechanical (shaft) energy

Viewing each stage of the process individually:
ΔE_{E}=−ΔE_{M} Eq.46
ΔE_{M}=−ΔE_{S} Eq.47

The negative signs are dictated by Conservation of Energy which requires that the decrease in one form of energy is equal to the increase in another form.

Eq.46 is the inductor charging stage when voltage v_{A} is applied to the excitation coil resulting in magnetic energy ΔE_{M} derived earlier in Eqs.12 and 17 and repeated here for convenience:

$$Δ {E}_{M} = \frac{1}{2} {i}^{2} L = \frac{1}{2 {μ}_{o}} {V}_{g} {B}_{g}^{2} \qquad Eq . 48$$

Conversion of magnetic energy ΔE_{M} into mechanical energy ΔE_{S}, as presented by Eq.47, must occur at constant flux inasmuch as the applied voltage is removed and the excitation coil short-circuited so that

$$v = n \frac{ⅆ ϕ}{ⅆ t} = n {A}_{g} ⅆ {B}_{g} / ⅆ t = 0$$

(see Eqs.5 and 14). Since A_{g} is constant in the present invention, the zero (short-circuited) coil voltage v constrains flux density to be constant because dB_{g}/dt=0. Thus B_{g} remains constant throughout the energy conversion stage. As mentioned before, with A_{g} and B_{g} both constant, the magnetic force will also be constant during the course of energy conversion.

If B_{g} is constant, then current i is constrained to be directly proportional to gap length l_{g} as indicated by Eq.22 which gives:

$${B}_{g} = {( \frac{i}{{l}_{g}} )}_{f} = {( \frac{i}{{l}_{g}} )}_{i} = constant$$

Where subscripts f and i indicate “final” and “initial” conditions of the energy conversion stage.

$${i}_{f} = {i}_{i} ( \frac{{l}_{g - f}}{{l}_{g - i}} ) \qquad Eq . 49$$

To verify Eq.47, begin by differentiating Eq.17:

$${dE}_{M} = \frac{1}{2 {μ}_{o}} {B}_{g}^{2} ⅆ {V}_{g} = \frac{1}{2 {μ}_{o}} {A}_{g} {B}_{g}^{2} ⅆ {l}_{g} \qquad Eq . 50$$

Next find ΔE_{S} by using the definition for mechanical energy in differential form as:
dE_{S}=Fdl_{g} Eq.51

Substituting Eq.34 for magnetic force F into Eq.51:

$${dE}_{S} = \frac{1}{2 {μ}_{o}} {A}_{g} {B}_{g}^{2} ⅆ {l}_{g} = Eq . 51 = ⅆ {E}_{M} \qquad Eq . 52$$

Integrating Eq.52:

$$\begin{matrix}Δ {E}_{S} = \frac{1}{2 {μ}_{o}} {A}_{g} {B}_{g}^{2} {\int }_{{l}_{g}}^{0} ⅆ {l}_{g} \\ = - ( \frac{1}{2 {μ}_{o}} ) {V}_{g} {B}_{g}^{2} \\ = - Δ {E}_{M} \\ = Eq . 17 = Eq . 18\end{matrix} \qquad Eq . 53$$

Constant piston force will create sinusoidal torque at the shaft such that average torque Tₐᵥₑ may be found by using Eq.34 for magnetic force F and allowing 2r=l_{g} at maximum stroke:

$$\begin{matrix}{T}_{ave} = \frac{2}{π} {T}_{p k} \\ = \frac{2}{π} rF \\ = \frac{2}{π} r \frac{{A}_{g} {B}_{g}^{2}}{2 {μ}_{o}} \\ = \frac{1}{π} ( \frac{1}{2 {μ}_{o}} {l}_{g} {A}_{g} {B}_{g}^{2} ) \\ = \frac{1}{π} ( \frac{1}{2 {μ}_{o}} {V}_{g} {B}_{g}^{2} ) \\ = \frac{1}{π} Δ {E}_{M}\end{matrix} \qquad Eq . 54$$

Notice that average torque Tₐᵥₑ, as given by Eq.54 for a reciprocating VR machine operating in the attractive-mode, is exactly the same as pole torque T_{P}=Tₜₒₜ/N_{P} of a conventional VRM operating in the expansive-mode (see Eq.40). This is not surprising considering the basic premise that torque, applied through an angle, is always predictable when converting magnetic energy into mechanical energy. If the quantity of magnetic energy is the same, then the torque produced will be the also be same regardless of the type of machine used.

Accordingly, Eq.54 becomes equivalent to Eq.40 as:

$${T}_{tot} = \frac{1}{π} {N}_{P} Δ {E}_{M - tot} \qquad Eq . 55$$

Where: ΔE_{M-tot}=total magnetic energy storage capacity of the machine.

For a given size machine, adding poles would not at first glance appear to result in increased torque. Because, the logic follows, even though there are more poles, each pole has proportionately less magnetic energy available for conversion. Therefore it would appear that net result is fixed storage capacity for a given size machine which results in the same torque.

This argument is actually correct when applied to pistons driven from a crankshaft. For a given engine size, displacement is not affected by the number of cylinders. Therefore engine torque is independent of cylinder number. The number of cylinders is actually comparable to the number of motor phases because, while the number of phases has no effect on torque, additional phases do redistribute torque in finer increments that reduces torque ripple, the same effect as adding more cylinders.

However, this line of reasoning does not apply to motor poles. Even though pole-number has no effect on total magnetic energy stored within a given size machine, the frequency of conversion of total stored magnetic energy does vary directly with pole number. The “rate of energy conversion”, or number of “flux reversals per unit time”, increases with higher pole number for a given shaft speed, which is not the case in a reciprocating engine by simply adding more cylinders within a fixed envelope. In other words, a higher cylinder number does not increase the rate of chemical energy conversion; it just reduces torque ripple. Rate of magnetic energy conversion is, by definition, the power rating of a machine. Adding poles increases the magnetic conversion rate. Shaft power therefore rises for a given speed with an increase in pole number. This effectively translates into higher torque because, from Eq.42:

$${P}_{S} = {T}_{tot} {ω}_{S} = ( \frac{2 π}{60} ) {T}_{tot} ( rpm ) or {T}_{tot} = ( \frac{60}{2 π} ) \frac{{P}_{S}}{( rpm ) } \qquad Eq . 56$$

Thus if power P_{S} increases at constant (rpm) due to an increase in pole number, then torque Tₜₒₜ necessarily increases proportionately.

Even though VRM machine torque is produced at a 50% duty cycle, the above equations are not to be multiplied by “½”. The equations represent simply the conversion of magnetic energy per shaft revolution irrespective of the time period during which the conversion process takes place.

In prior-art VRM practice employing the magnetic expansive-mode, magnetic co-energy is co-created simultaneous with torque production in a single-step process. This co-energy is exactly equal to the shaft energy making salvaging and recycling imperative in order to obtain acceptable machine efficiency.

By contrast, the present invention entails magnetic attractive force which consumes magnetic energy in a 2-step process. Only a small amount of residual magnetic energy remains at the end of the torque cycle which is readily recovered and returned to the power source.

Both conventional and a motor constructed in accordance with the present invention have conversion methods that yield the same net mechanical energy upon conversion of the same quantity of magnetic energy, as stipulated by the Law of Conservation of Energy. However, eliminating the necessity of co-energy recovery following each torque cycle permits a greater portion of the cycle to be dedicated strictly to torque production. Consequently, the present invention is capable of generating more torque per unit weight than a conventional VRM.

Co-energy recovery schemes impose a sacrifice of torque in conventional VRM practice. Avoidance of this sacrifice comes at the expense of lower machine efficiency resulting from incomplete co-energy reclamation. The present invention can therefore realize higher operating efficiency inasmuch as the necessity for co-energy recovery has been largely eliminated.

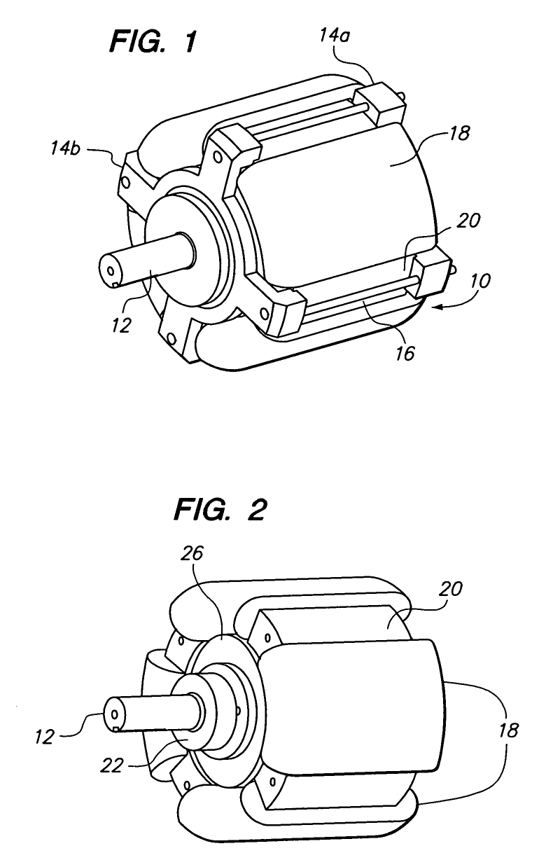

Referring to FIGS. 1-4, a rotating electric motor 10 constructed in accordance with the present invention is shown. The motor 10 is a single phase, 4-pole motor that illustrates one embodiment. It will be appreciated by those of ordinary skill in the art that multiple phases and poles can be added to the motor without departing from the scope of the invention.

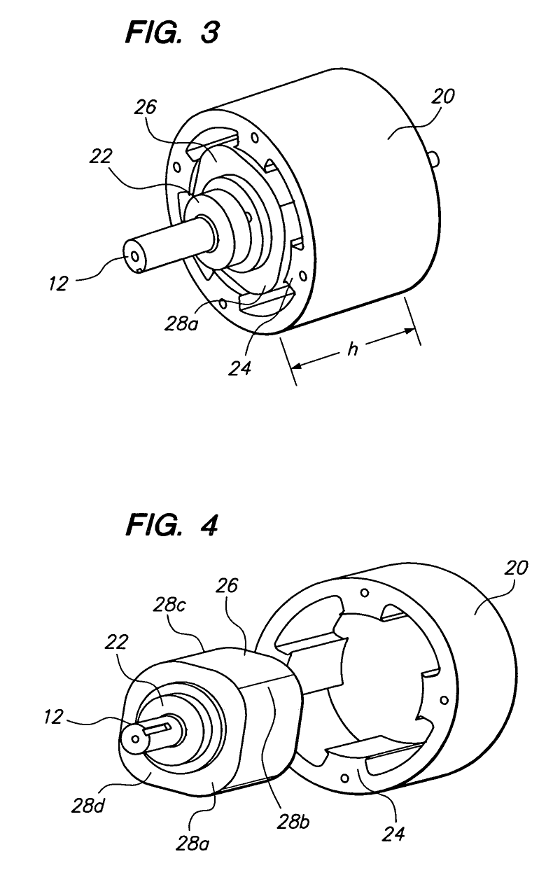

The motor 10 has a shaft 12 that supported by end bells 14a and 14b with bearings 22. The end bells 14a, 14b are connected with four tie rods 16 that extend the length of the motor 10. Disposed between the tie rods 16 are four winding coils 18 that wrap around the stator core 20 that is formed from steel laminations. FIG. 2 illustrates the motor 10 with end bells 14a and 14b removed. FIG. 3 illustrates the motor 10 with the stator windings 18 removed to expose the stator core 20 in greater detail. The stator core 20 has four stator poles 24 formed therein. Furthermore, FIG. 3 illustrates the laminated rotor core 26 attached to the shaft 12 and shaft bearings 22. Referring to FIG. 4, an exploded view of the rotor core 26 and the stator core 20 is shown. As will be further explained below, the rotor core 26 is formed with four rotor lobes 28a, 28b, 28c and 28d.

The four winding coils 18 are wrapped around the periphery of the stator core 20 between the four stator poles 24 such that the coil axis is aligned circumferentially with the stator back iron. The motor 10 also operates with a conventional winding format whereby the winding is wrapped around each pole with the coil axis oriented parallel to the poles. The arrangement shown in FIGS. 1 and 2 provides increased cooling surface area and greater ease of assembly because there is a large slot volume between the poles of the machine.

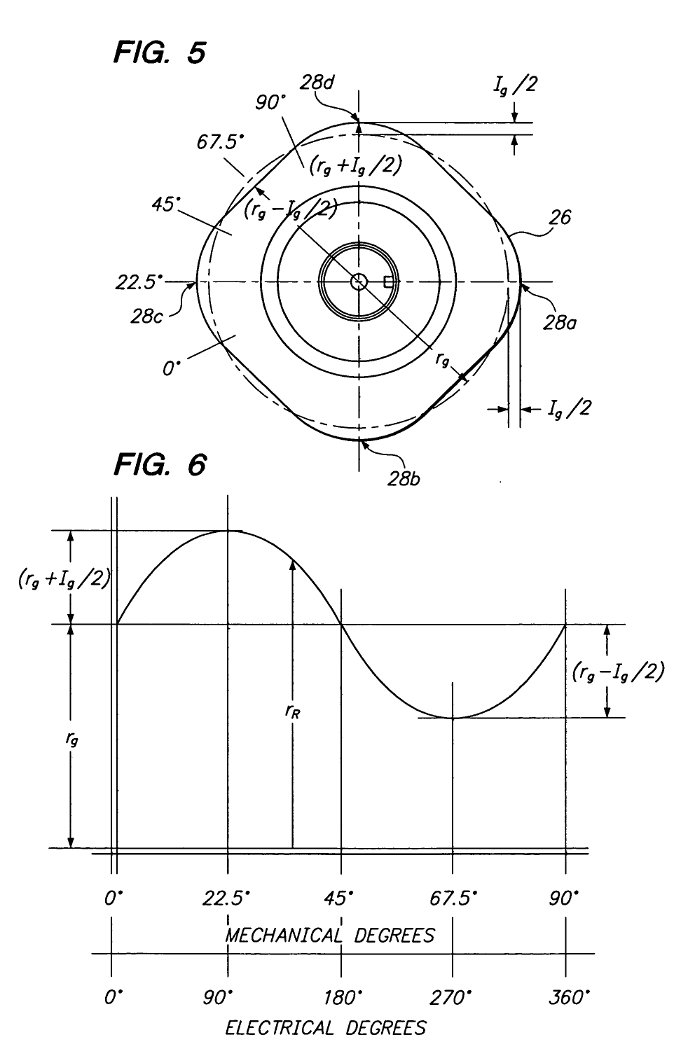

As previously discussed, the rotor core 26 is formed with four distinct lobes 28a-28d. As seen in FIG. 5, the circumference of the rotor varies sinusoidally above and below the mean rotor radius r_{g} represented by the broken line. In this respect, the radius of curvature r_{R} defining the rotor surface can be expressed as:

$${r}_{R} = [ {r}_{g} + \frac{{l}_{g}}{2} sin {N}_{P} {θ}_{M} ] . \qquad Eq . 57$$

Where: r_{R}=rotor radius of curvature
r_{g}=mean rotor radius
N_{P}=number of poles
θ_{M}=mechanical degrees
l_{g}=maximum length of air gap between stator pole and rotor lobe

The radius of curvature of the rotor circumference defines peaks and valleys on the surface of the rotor 26 if laid flat. FIG. 6 depicts the surface of the rotor 26 laid out with corresponding mechanical degrees for a four pole configuration shown with electrical degrees for a complete torque cycle include a coasting period. The torque-production interval comprises the region between 67.5° and 22.5° mechanical degrees corresponding to 180 electrical degrees. The remaining 180 electrical degrees of a complete torque cycle are reserved for the coasting period.

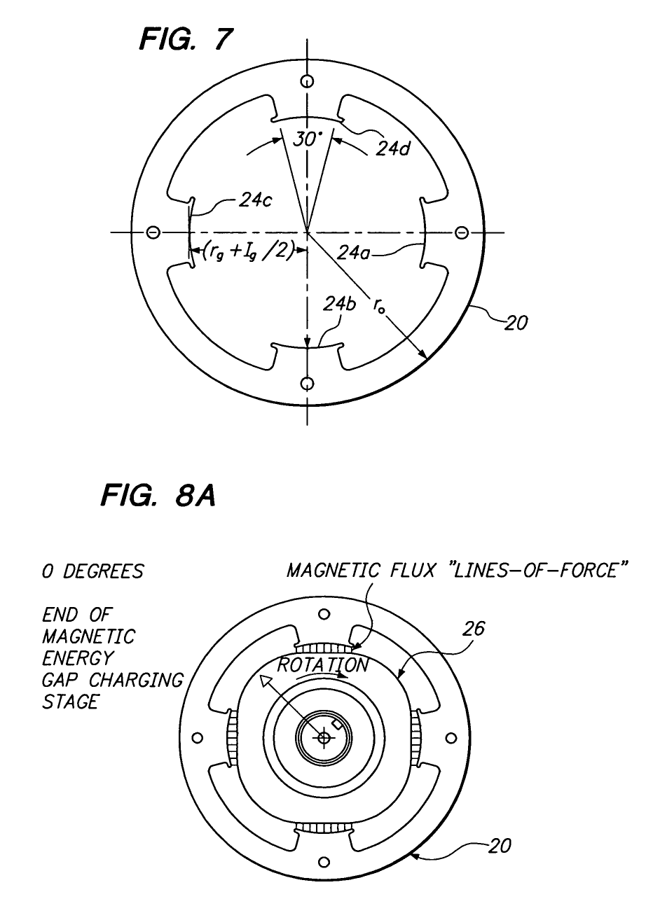

Referring to FIG. 7, the geometry of the stator core 20 is shown. The stator core 20 has four stator poles 24a-d each comprising about 30 mechanical degrees and with a minimum inside radius of

$$( {r}_{g} + \frac{{l}_{g}}{2} ) .$$

It will be appreciated by those of ordinary skill in the art, that the number and shape of the poles 24 may vary.

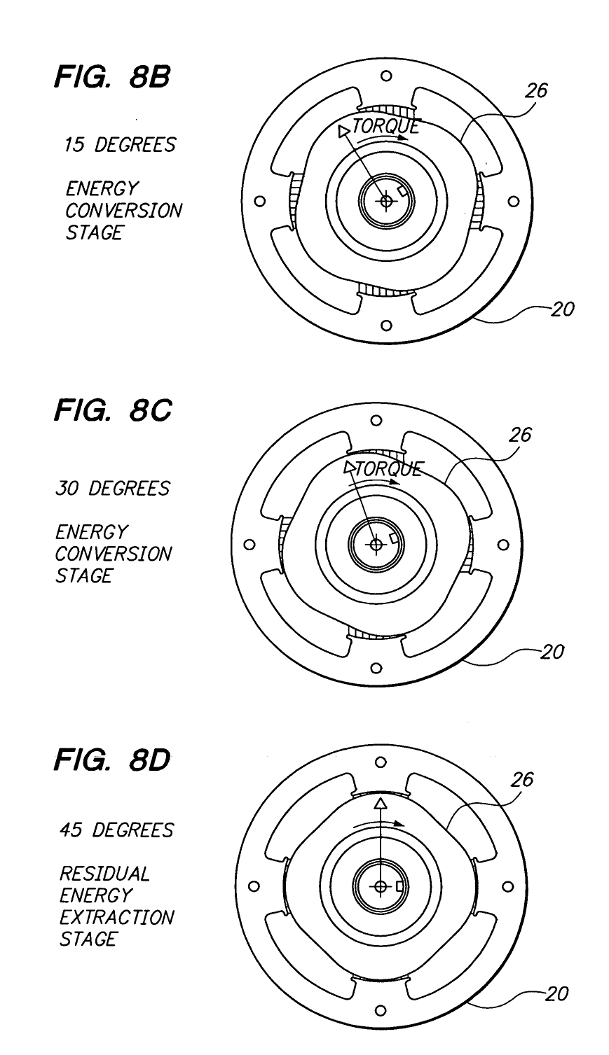

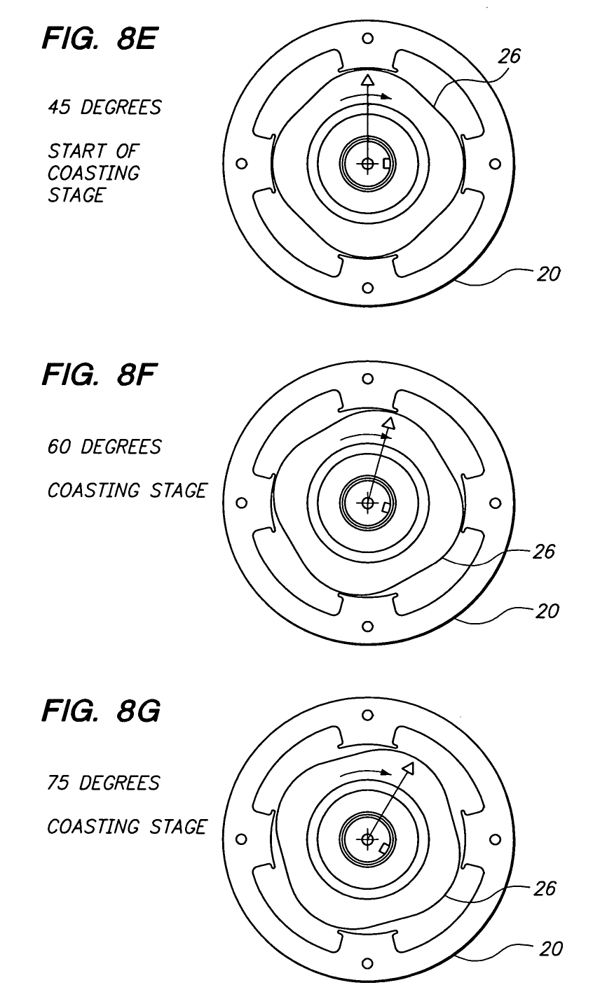

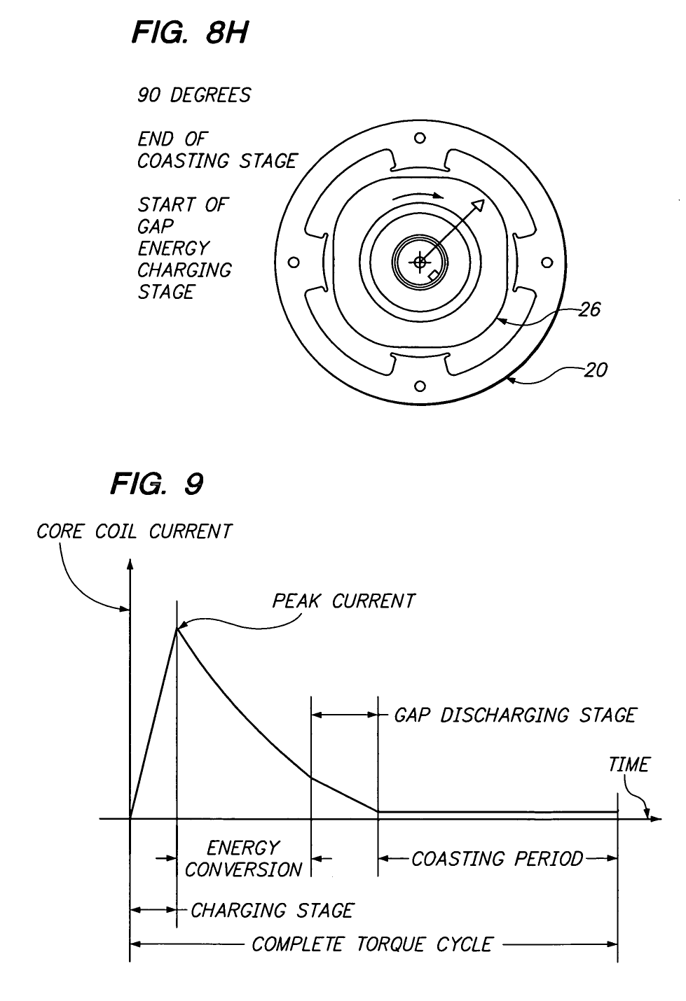

FIGS. 8A-H illustrates the four pole machine 10 progressing in 15° degree increments through a complete torque cycle. More specifically, FIGS. 8A-D represent the torque producing interval of the cycle, while FIGS. 8D-H represent the coasting interval of the cycle. Vertical hatching portrays the magnetic flux between the stator poles and the surface of the rotor with a reduction of flux volume occurring as torque production proceeds.

The production of torque proceeds along three distinct phases as shown by FIGS. 8 and 9. In the “charging stage”, magnetic energy is introduced into the rotor-stator gap volume when machine inductance is nearly constant at the beginning of the torque cycle. This stage replicates the condition of a static inductor due to slow changes in gap volume. During this stage, external power is applied to the motor winding. Back emf is simply the self-induced voltage of a static inductor matching the applied voltage waveform.

In the “energy conversion stage”, magnetic energy within the gap between the stator and rotor is converted to mechanical energy during the portion of the torque interval when the machine inductance is changing quickly due to rapid variation of the gap volume (i.e., when the gap length varies). Throughout this stage, the external power remains disconnected while the machine winding is short circuited to allow internal circulating current to decay non-dissipatively as inductor energy is extracted and converted into shaft energy.

In the “discharging stage”, residual magnetic energy is reclaimed during nearly constant inductance when the gap volume is again changing slowly upon completion of the torque cycle. During this stage, the machine behaves as a static inductor containing remnant energy that is easily returned to the DC power supply.

Conventional VRM salient poles involve prominent protrusions jutting abruptly outward form the center of the rotor. Accordingly, magnetic flux appears mostly on the pole periphery surface within the overlap region of opposing rotor and stator poles. As such, no appreciable flux fills the space between rotor or stator poles.

However, during torque production of the motor 10, magnetic flux lines of force attach to every point along the surface of the rotor 26. During the charging stage of the torque interval, flux fills the valley between midway between the rotor lobes 28. Peak torque occurs in the region of maximum variation of curvature which is approximately halfway between the valley and the peak of the lobe 28. During residual energy recovery, the flux lines are concentrated around the peak of the lobe 28. At all points throughout the torque interval, flux density remains constant when dissipative decay losses are assumed negligible.

Similar to the conventional VRM, a varying gap volume is entrained between the rotor core 26 and the stator core 20. However, the singular difference between the conventional VRM and the motor 10 constructed in accordance with the present invention is the manner in which gap volume is caused to vary as required by any VRM. In the motor 10, the majority of gap variation is achieved by altering the radial length of the gap while maintaining constant gap area. Consequently, magnetic attractive forces are the primary mechanism for torque production.

It is necessary to saturate the stator poles for successful implementation. As used herein, saturation refers to varying degrees of partial saturation wherein magnetic permeability varies markedly as a function of flux density.

As previously discussed above, the shape of the lobes 28 for the rotor core 26 enable production of torque. However, by necessity, the stator core 20 does not have a profile corresponding to the shape of the rotor core 26. Therefore, without some measure of stator pole saturation, the required reaction torque of the stator could not exist. This is because the lines of force, attached to the stator pole faces, are directed radially rather than tangentially. With no circumferential (tangential) component, the lines of force make no contribution to torque generation because there is no reaction torque as required by the Law of Conservation of Torque. Most torque is produced by magnetic distortion of the pole face in order to create an effective magnetic stator pole shape corresponding partially to the rotor pole shape. This is not an actual physical distortion of the stator pole material but rather a change of magnetic properties, namely permeability, that alter the magnetic geometry of the pole. In other words, the effective magnetic pole geometry is distorted by non-uniform saturation of the stator pole. The resulting magnetic stator pole has an effective surface normal to the tangential direction as required to produce reaction torque. This favorable magnetic adjustment, due to stator pole saturation and the rotor pole shape (lobes), arises from a natural tendency to create a gap of uniform length. A shorter gap length carries higher flux density and therefore saturates to a greater degree than locations of a longer gap length. The resulting gap has a more uniform flux density across the pole face than would be apparent from the physical pole geometry alone.

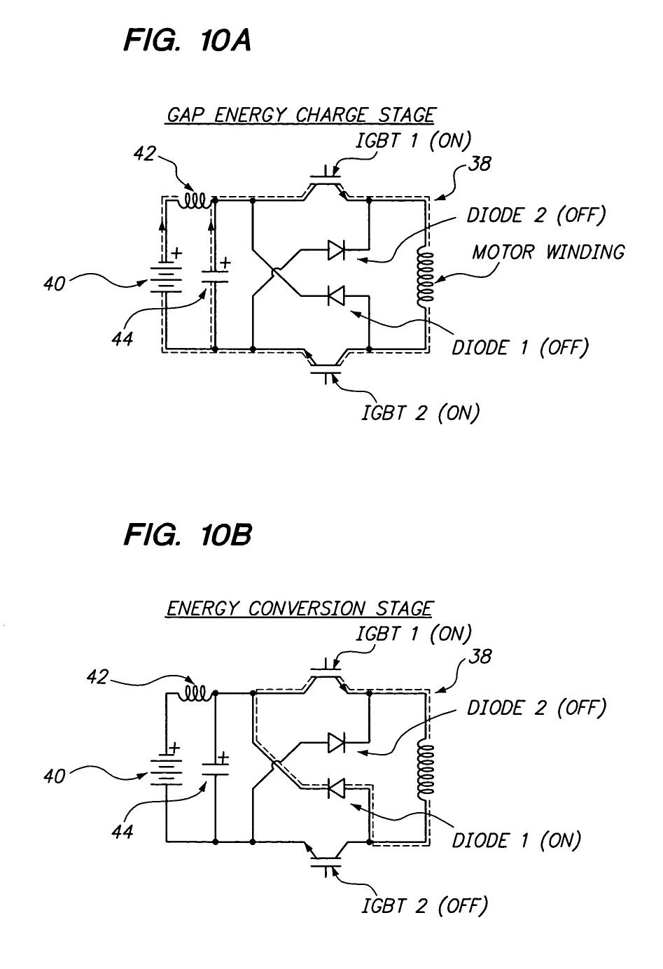

Referring to FIGS. 10A-C, a drive circuit 38 for the motor 10 is shown. The drive circuit 38 has a DC power supply 40 connected to a filter inductor 42 and a filter capacitor 44. The filter inductor 42 and the filter capacitor 44 reduce the impact of current surges on the DC power supply 40 during the first stage (gap charging), as well as during the third stage of residual energy recovery (gap discharging). The drive circuit 38 further includes first and second solid-state power switches (IGBT 1 and IGBT2), as well as first and second diodes (diode 1 and diode 2) connected together as shown in FIGS. 10A-C.

One drive circuit is required per machine phase. The drive circuit 38 illustrated in FIGS. 10A-C is shown in three different conduction states corresponding to the three torque stages described above. The dotted lines in FIGS. 10A-C indicate the conducting portions of the circuit.

Referring to FIG. 10A, during the first stage where the gap is charged with magnetic energy, both IGBT 1 and IGBT 2 are on and both diode 1 and diode 2 are off thereby allowing current to flow through the motor winding. The energy conserving stage is shown In FIG. 10B where the external power source (i.e., DC power supply 40) is isolated. In this stage, IGBT 1 and diode 1 are conducting. In the discharge stage of residual energy recovery, both IGBT 1 and IGBT 2 are off and diode 1 and diode 2 are on. Accordingly, residual energy can flow back into the DC power supply 40. It will be recognized by those of ordinary skill in the art, that a control circuit can be created that controls the conduction of IGBT 1 and IGBT 2.

Generator mode operation of the motor 10 with the drive circuit 38 follows the same sequential order of FIGS. 10A-C except timing of the rotor position relative to the electrical switching is shifted 90° (electrical) the gap is charged with a small amount of excitation energy injected into the gap volume at it minimum value where, under motor mode, residual energy would have been withdrawn with the circuit conducting as FIG. 1A. Next, with FIG. 10B operative, the gap volume expands and coil current increases at constant flux density which represent a buildup of magnetic energy. Finally, at maximum gap volume, both IGBT 1 and IGBT 2 are turned off as shown in FIG. 10C and the accumulated gap magnetic energy is discharged into the DC load which was formerly the DC source under motor mode.

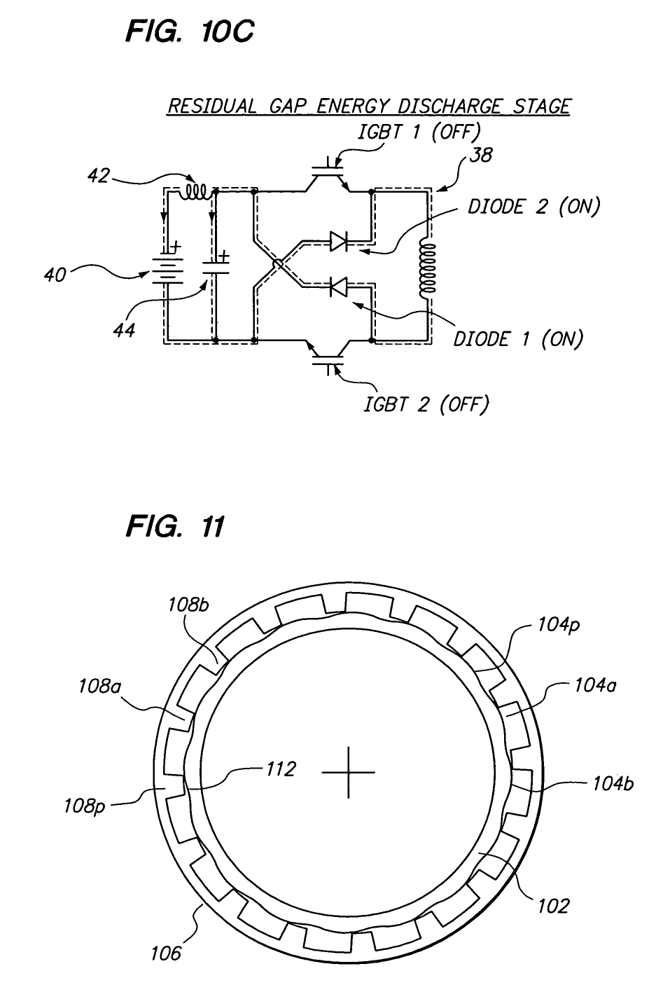

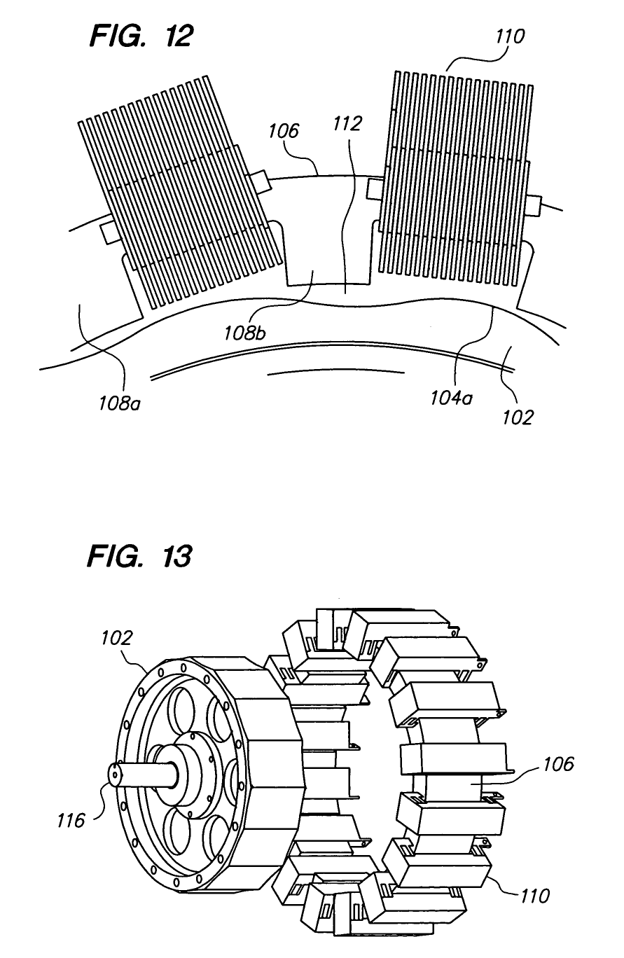

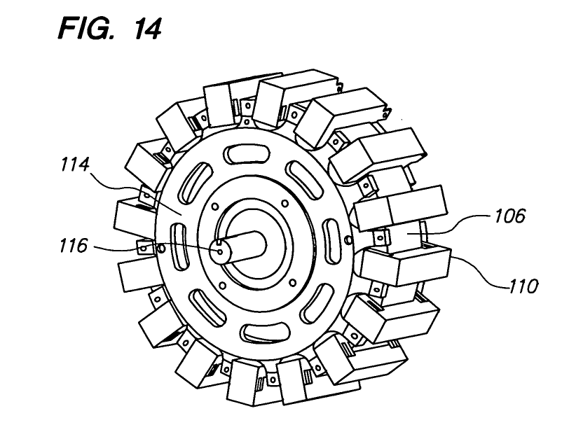

As previously mentioned, it is also possible for the motor 10 to have multiple poles. For example, FIG. 11 shows a rotor core 102 having sixteen lobes 102a to 102p. The motor 10 also has a stator core 106 with sixteen poles 108a to 108p. The operation of the motor with the multiple lobes 102 and multiple poles 108 is similar to the four pole motor 10 as previously described. FIG. 12 is an exploded view of the interface of the stator poles 108 and rotor lobes 102 shown in FIG. 11 but with the addition of winding coils 110. As seen in FIG. 12, the length of an air gap 112 formed between a stator pole 108 and the rotor core 102 varies over the length of the rotor lobe 102. FIG. 13 is an exploded view of the sixteen pole motor, while FIG. 14 shows an assembled sixteen pole motor with end bell 114 and shaft 116.

It will be appreciated by those of ordinary skill in the art that the concepts and techniques described herein can be embodied in various forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalents thereof are intended to be embraced.

What is claimed:

1. An electric machine comprising:
a stator having an inner circumference having at least one pole; and
a rotor having at least one lobe formed on an outer circumference thereof, the rotor being sized and configured to be rotatable within the inner circumference of the stator, the lobe defining an air gap having a variable length between the stator pole and the rotor lobe as a function of rotor angular position relative to the stator.

2. The machine of claim 1 wherein the rotor comprises a lobe for each pole of the motor.

3. The machine of claim 1 wherein the rotor is configured such that the radius of the rotor surface varies generally sinusoidally to define the lobe of the rotor.

4. The machine of claim 3 wherein the lobes are generally formed on the rotor according to the following equation:
$${r}_{R} = [ {r}_{g} + \frac{{l}_{g}}{2} sin {N}_{P} {θ}_{M} ]$$
where: r_{R}=rotor surface radius of curvature
r_{g}=mean rotor surface radius
N_{P}=number of poles
θ_{M}=mechanical degrees
l_{g}=length of air gap between stator and rotor.

5. The machine of claim 1 further comprising at least one winding disposed around the stator.

6. The machine of claim 5 further comprising a drive circuit in electrical communication with the winding in order to energize the winding.

7. The machine of claim 1 configured to operate as a motor.

8. The machine of claim 1 configured to operate as a generator.

9. A variable reluctance machine comprising:
a generally circularly shaped stator core having at least one pole and at least one winding disposed thereon; and
a rotor core configured to be insertable into the stator core and having at least one lobe, the rotor core being configured to define a gap between the stator core pole and the rotor core lobe, the radius of the rotor core lobe being configured to vary the average length of the gap between the rotor core lobe and the stator core pole as a function of rotor angular position relative to the stator when rotating within the stator core.

10. The machine of claim 9 wherein the radius of the rotor core surface varies to define at least one lobe on an outer circumference of the rotor core.

11. The machine of claim 10 wherein the radius of the rotor core generally varies according the following equation:
$${r}_{R} = [ {r}_{g} + \frac{{l}_{g}}{2} sin {N}_{P} {θ}_{M} ]$$
where: r_{R}=rotor surface radius of curvature
r_{g}=mean rotor surface radius
N_{P}=number of poles
θ_{M}=mechanical degrees
l_{g}=length of air gap between stator and rotor.

12. The machine of claim 10 wherein the number of lobes formed on the rotor corresponds to the number of poles of the motor.

13. The machine of claim 9 further comprising at least one winding disposed around the stator.

14. The machine of claim 13 further comprising a drive circuit in electrical communication with the winding in order to energize the winding.

15. The machine of claim 9 configured to operate as a motor.

16. The machine of claim 9 configured to operate as a motor.

17. A method of rotating a shaft of an electric machine having a rotor with lobes and a stator with stator poles, the method comprising the steps of:
energizing a coil disposed around the stator with an electrical power source;
defining a gap having a length between the stator and the rotor;
varying the length of the gap between the stator pole and the rotor lobe with the shape of the rotor lobe, as a function of rotor angle relative to the stator, in order to create a variable reluctance machine.

18. The method of claim 17 wherein the coil is energized with a drive circuit.

19. The method of claim 18 wherein the drive circuit controls a magnetic field formed in the gap between the stator pole and the rotor lobe.

20. The method of claim 18 wherein the shape of the rotor comprises lobes formed on an outer circumference thereof.

21. The method of claim 18 wherein the machine is operated as a motor.

22. The method of claim 18 wherein the machine is operated as a generator.
